(19) United States
(12) Patent Application Publication
(10) Pub. No.: US 2023/0422150 A1
(43) Pub. Date: Dec. 28, 2023

(54) SYSTEM INFORMATION BLOCK REACQUISITION AFTER SYSTEM INFORMATION SCHEDULE MODIFICATION

(71) Applicant: QUALCOMM Incorporated, San Diego, CA (US)

(72) Inventors: Muralidharan MURUGAN, Hyderabad (IN); Yi REN, Shanghai (CN); Nitin PANT, San Diego, CA (US); Umesh PHUYAL, San Diego, CA (US); Jun DENG, Shanghai (CN); Prabhanjan Reddy PINGILI, Hyderabad, Telangana (IN)

(21) Appl. No.: 18/253,184

(22) PCT Filed: Jan. 21, 2021
(86) PCT No.: PCT/CN2021/073014

§ 371 Date: May 16, 2023

(51) Int. Cl. H04W 48/08

(52) U.S. Cl. CPC H04W 48/08

(57) ABSTRACT

Various aspects of the present disclosure generally relate to wireless communication. In some aspects, a user equipment (UE) may acquire a scheduling system information block (SIB) that includes scheduling information for a set of SIBs. The UE may detect a failure to acquire a SIB, included in the set of SIBs, using the scheduling information. The UE may acquire an updated scheduling SIB, that includes updated scheduling information for the set of SIBs, based at least in part on detecting the failure to acquire the SIB included in the set of SIBs. The UE may acquire the SIB, included in the set of SIBs, using the updated scheduling information. Numerous other aspects are provided.

### FIELD OF THE DISCLOSURE

Aspects of the present disclosure generally relate to wireless communication and specifically, to techniques and apparatuses for system information block reacquisition after system information schedule modification.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, and even global level. New Radio (NR), which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDMA (for example, also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements are applicable to other multiple access technologies and the telecommunication standards that employ these technologies.

When transmission of an earthquake and tsunami warning system (ETWS) message or a commercial mobile alert system (CMAS) message starts or stops, a base station may update a system information block (SIB), such as SIB1, to add or remove scheduling information for one or more SIBs relating to the ETWS message or the CMAS message. A change to scheduling and transmission of the SIBs relating to ETWS or CMAS messages may impact the scheduling and transmission of one or more other SIBs, such as SIB19 and above. If a UE reads SIB1 to obtain scheduling information for the SIB19 and above, and then ETWS or CMAS transmission starts or stops after the UE reads SIB1 and before the UE acquires an impacted SIB (for example, SIB19 or above), then the UE may be unable to acquire the impacted SIB. For example, the UE may attempt to acquire the impacted SIB in a location (for example, a time-frequency location) in which the impacted SIB is no longer transmitted (for example, due to a SIB schedule modification). This may cause the UE to be unable to use one or more UE capabilities or functionalities.

### SUMMARY

In some aspects, a method of wireless communication performed by a user equipment (UE) includes acquiring a scheduling system information block (SIB) that includes scheduling information for a set of SIBs. The method may include detecting a failure to acquire a SIB, included in the set of SIBs, using the scheduling information. The method may include acquiring an updated scheduling SIB, that includes updated scheduling information for the set of SIBs, based at least in part on detecting the failure to acquire the SIB included in the set of SIBs. The method may include acquiring the SIB, included in the set of SIBs, using the updated scheduling information.

In some aspects, a method of wireless communication performed by a UE includes acquiring a scheduling SIB that includes scheduling information for a set of SIBs. The method may include detecting a failure to acquire a SIB, included in the set of SIBs, using the scheduling information. The method may include determining, after detecting the failure, whether the UE is required to acquire the SIB, included in the set of SIBs, to support a capability of the UE. The method may include acquiring or refraining from acquiring an updated scheduling SIB, that includes updated scheduling information for the set of SIBs, based at least in part on whether the UE is required to acquire the SIB, included in the set of SIBs, to support the capability of the UE.

In some aspects, a UE for wireless communication includes a memory and one or more processors operatively coupled to the memory. The UE may be configured to acquire a scheduling SIB that includes scheduling information for a set of SIBs. The UE may be configured to detect a failure to acquire a SIB, included in the set of SIBs, using the scheduling information. The UE may be configured to acquire an updated scheduling SIB, that includes updated scheduling information for the set of SIBs, based at least in part on detecting the failure to acquire the SIB included in the set of SIBs. The UE may be configured to acquire the SIB, included in the set of SIBs, using the updated scheduling information.

In some aspects, a UE for wireless communication includes a memory and one or more processors operatively coupled to the memory. The UE may be configured to acquire a scheduling SIB that includes scheduling information for a set of SIBs. The UE may be configured to detect a failure to acquire a SIB, included in the set of SIBs, using the scheduling information. The UE may be configured to determine, after detecting the failure, whether the UE is required to acquire the SIB, included in the set of SIBs, to support a capability of the UE. The UE may be configured to acquire or refrain from acquiring an updated scheduling SIB, that includes updated scheduling information for the set of SIBs, based at least in part on whether the UE is required to acquire the SIB, included in the set of SIBs, to support the capability of the UE.

In some aspects, a non-transitory computer-readable medium storing a set of instructions for wireless communication includes one or more instructions that, when executed by one or more processors of a UE, cause the UE to acquire a scheduling SIB that includes scheduling information for a set of SIBs. The one or more instructions may cause the UE to detect a failure to acquire a SIB, included in the set of SIBs, using the scheduling information. The one or more instructions may cause the UE to acquire an updated scheduling SIB, that includes updated scheduling information for the set of SIBs, based at least in part on detecting the failure to acquire the SIB included in the set of SIBs. The one or more instructions may cause the UE to acquire the SIB, included in the set of SIBs, using the updated scheduling information.

In some aspects, a non-transitory computer-readable medium storing a set of instructions for wireless communication includes one or more instructions that, when executed by one or more processors of a UE, cause the UE to acquire a scheduling SIB that includes scheduling information for a set of SIBs. The one or more instructions may cause the UE to detect a failure to acquire a SIB, included in the set of SIBs, using the scheduling information. The one or more instructions may cause the UE to determine, after detecting the failure, whether the UE is required to acquire the SIB, included in the set of SIBs, to support a capability of the UE. The one or more instructions may cause the UE to acquire or refrain from acquiring an updated scheduling SIB, that includes updated scheduling information for the set of SIBs, based at least in part on whether the UE is required to acquire the SIB, included in the set of SIBs, to support the capability of the UE.

In some aspects, an apparatus for wireless communication includes means for acquiring a scheduling SIB that includes scheduling information for a set of SIBs. The apparatus may include means for detecting a failure to acquire a SIB, included in the set of SIBs, using the scheduling information. The apparatus may include means for acquiring an updated scheduling SIB, that includes updated scheduling information for the set of SIBs, based at least in part on detecting the failure to acquire the SIB included in the set of SIBs. The apparatus may include means for acquiring the SIB, included in the set of SIBs, using the updated scheduling information.

In some aspects, an apparatus for wireless communication includes means for acquiring a scheduling SIB that includes scheduling information for a set of SIBs. The apparatus may include means for detecting a failure to acquire a SIB, included in the set of SIBs, using the scheduling information. The apparatus may include means for determining, after detecting the failure, whether the apparatus is required to acquire the SIB, included in the set of SIBs, to support a capability of the apparatus. The apparatus may include means for acquiring or refraining from acquiring an updated scheduling SIB, that includes updated scheduling information for the set of SIBs, based at least in part on whether the apparatus is required to acquire the SIB, included in the set of SIBs, to support the capability of the apparatus.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station (BS) in communication with a user equipment (UE) in a wireless network in accordance with the present disclosure.

FIGS. 3 and 4 are diagrams illustrating examples of system information block (SIB) scheduling in accordance with the present disclosure.

FIG. 5 is a diagram illustrating an example associated with SIB reacquisition after system information schedule modification in accordance with the present disclosure.

FIGS. 6 and 7 are flowcharts illustrating example processes performed, for example, by a UE that supports SIB reacquisition after system information schedule modification in accordance with the present disclosure.

FIGS. 8 and 9 are block diagrams of example apparatuses for wireless communication that support SIB reacquisition after system information schedule modification in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to system information block (SIB) reacquisition after system information schedule modification. Some aspects more specifically relate to enabling a user equipment (UE) to reacquire SIB1 after failing to acquire a SIB scheduled by SIB1. In some aspects, the UE may obtain updated SIB scheduling information in the reacquired SIB1, and may use that updated SIB scheduling information to reacquire the SIB that the UE previously failed to acquire. In some aspects, the SIB that the UE fails to acquire may be SIB19 or above. In some aspects, the failure of the UE to acquire the SIB may be due to a beginning or an end of transmission of an earthquake and tsunami warning system (ETWS) message or a commercial mobile alert system (CMAS) message. In some aspects, the UE may only reacquire SIB1 or the failed SIB if the UE is required to obtain the failed SIB to support a capability of the UE.

Particular aspects of the subject matter described in this disclosure can be implemented to realize one or more of the following potential advantages. In some examples, the described techniques can be used to acquire a SIB, that supports a capability of the UE, that the UE would otherwise be unable to timely acquire. In some examples, the described techniques reduce communication errors and conserve resources of the UE (for example, memory resources or processing resources) that would otherwise be used in a failed attempt to acquire the SIB in an outdated time domain resource. In some examples, the described techniques enable the UE to acquire an emergency notification, such as an ETWS notification or a CMAS notification, without a loss of functionality relating to content carried in a SIB that is rescheduled due to the emergency notification.

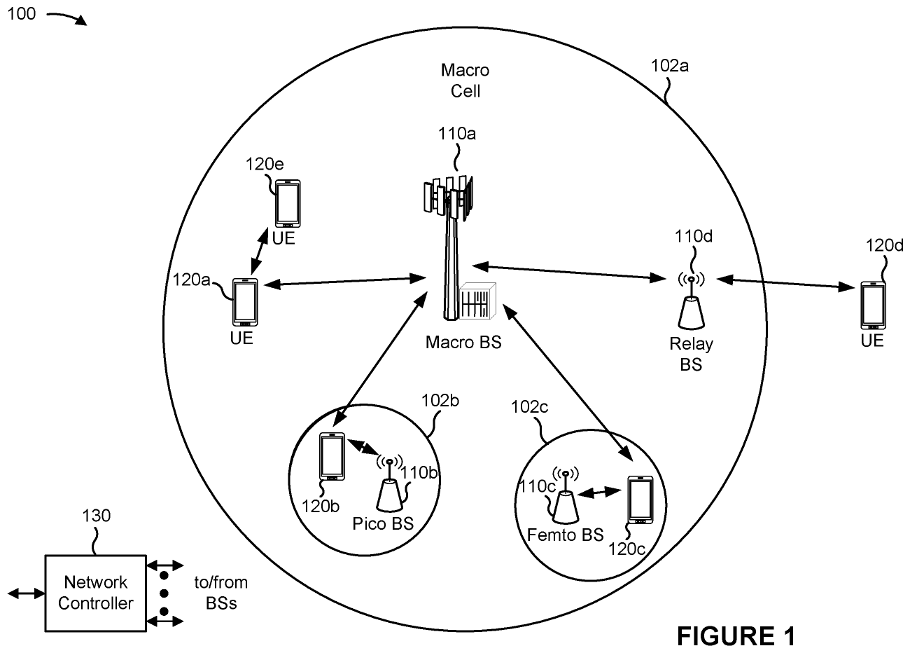

FIG. 1 is a diagram illustrating an example of a wireless network in accordance with the present disclosure. The wireless network may be or may include elements of a 5G (NR) network or an LTE network, among other examples. The wireless network may include one or more base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, or a transmit receive point (TRP), among other examples. Each BS may provide communication coverage for a particular geographic area. In 3GPP, the term “cell” can refer to a coverage area of a BS or a BS subsystem serving this coverage area, depending on the context in which the term is used.

A BS may provide communication coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. A BS may support one or multiple (for example, three) cells.

The wireless network may be a heterogeneous network that includes BSs of different types, such as macro BSs, pico BSs, femto BSs, or relay BSs. These different types of BSs may have different transmit power levels, different coverage areas, and different impacts on interference in the wireless network. For example, macro BSs may have a high transmit power level (for example, 5 to 40 watts) whereas pico BSs, femto BSs, and relay BSs may have lower transmit power levels (for example, 0.1 to 2 watts). In the example shown in FIG. 1, a BS 110a may be a macro BS for a macro cell 102a, a BS 110b may be a pico BS for a pico cell 102b, and a BS 110c may be a femto BS for a femto cell 102c. A network controller 130 may couple to the set of BSs 102a, 102b, 110a and 110b, and may provide coordination and control for these BSs. Network controller 130 may communicate with the BSs via a backhaul. The BSs may also communicate with one another, for example, directly or indirectly via a wireless or wireline backhaul.

In some aspects, a cell may not be stationary, rather, the geographic area of the cell may move in accordance with the location of a mobile BS. In some aspects, the BSs may be interconnected to one another or to one or more other BSs or network nodes (not shown) in the wireless network through various types of backhaul interfaces, such as a direct physical connection or a virtual network, using any suitable transport network.

The wireless network may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, or a relay, among other examples.

UEs 120 (for example, 120a, 120b, 120c) may be dispersed throughout the wireless network, and each UE may be stationary or mobile. A UE may also be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless medium.

Some UEs may be considered machine-type communication (MTC) or evolved or enhanced machine-type communication (eMTC) UEs. MTC and eMTC UEs include, for example, robots, drones, remote devices, sensors, meters, monitors or location tags, among other examples, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband internet of things) devices. Some UEs may be considered a Customer Premises Equipment (CPE). UE 120 may be included inside a housing that houses components of UE 120, such as processor components or memory components, among other examples.

In general, any quantity of wireless networks may be deployed in a given geographic area. Each wireless network may support a particular radio access technology (RAT) and may operate on one or more frequencies or frequency channels. A frequency may also be referred to as a carrier among other examples. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly with one another using one or more sidelink channels (for example, without using a base station 110 as an intermediary). For example, the UEs 120 may communicate using peer-to-peer (P2P) communications, device-to-device (D2D) communications, a vehicle-to-everything (V2X) protocol (for example, which may include a vehicle-to-vehicle (V2V) protocol or a vehicle-to-infrastructure (V2I) protocol), a mesh network, or a combination thereof. In such examples, the UE 120 may perform scheduling operations, resource selection operations, or other operations described elsewhere herein as being performed by the base station 110.

Devices of the wireless network may communicate using the electromagnetic spectrum, which may be subdivided based on frequency or wavelength into various classes, bands, or channels. For example, devices of the wireless network may communicate using an operating band having a first frequency range (FR1), which may span from 410 MHz to 7.125 GHz. As another example, devices of the wireless network may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” may broadly represent frequencies less than 6 GHz, frequencies within FR1, mid-band frequencies (for example, greater than 7.125 GHz), or a combination thereof. Similarly, unless specifically stated otherwise, it should be understood that the term “millimeter wave” may broadly represent frequencies within the EHF band, frequencies within FR2, mid-band frequencies (for example, less than 24.25 GHz), or a combination thereof. The frequencies included in FR1 and FR2 may be modified, and techniques described herein are applicable to those modified frequency ranges.

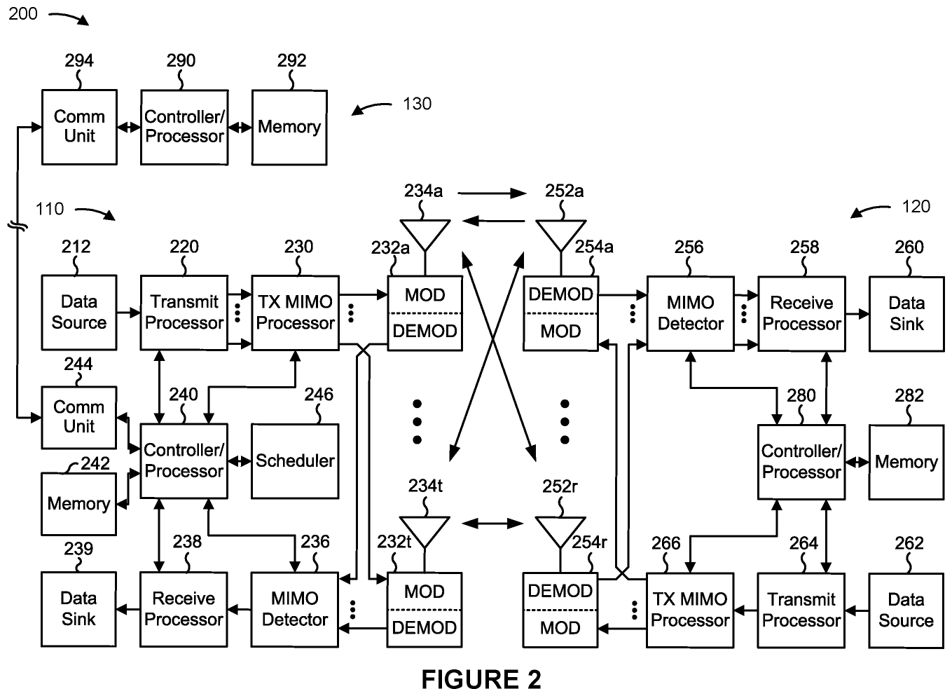

FIG. 2 is a diagram illustrating an example base station in communication with a UE in a wireless network in accordance with the present disclosure. The base station may correspond to base station 110 of FIG. 1. Similarly, the UE may correspond to UE 120 of FIG. 1.

Base station 110 may be equipped with T antennas 234a through 234t, and UE 120 may be equipped with R antennas 252a through 252r, where in general T≥1 andR≥1. At base station 110, a transmit processor 220 may receive data from a data source 212 for one or more UEs, select one or more modulation and coding schemes (MCSs) for each UE based at least in part on channel quality indicators (CQIs) received from the UE, process (for example, encode) the data for each UE based at least in part on the MCS(s) selected for the UE, and provide data symbols for all UEs. Transmit processor 220 may also process system information (for example, for semi-static resource partitioning information (SRPI) among other examples) and control information (for example, CQI requests, grants, or upper layer signaling) and provide overhead symbols and control symbols. Transmit processor 220 may also generate reference symbols for reference signals and synchronization signals. A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each MOD 232 may process a respective output symbol stream (for example, for OFDM among other examples) to obtain an output sample stream. Each MOD 232 may further process (for example, convert to analog, amplify, filter, and upconvert) the output sample stream to obtain a downlink signal. T downlink signals from MODs 232a through 232t may be transmitted via T antennas 234a through 234t, respectively.

At UE 120, antennas 252a through 252r may receive the downlink signals from base station 110 or other base stations and may provide received signals to R demodulators (DEMODs) 254a through 254r, respectively. Each DEMOD 254 may condition (for example, filter, amplify, downconvert, and digitize) a received signal to obtain input samples. Each DEMOD 254 may further process the input samples (for example, for OFDM) to obtain received symbols. A MIMO detector 256 may obtain received symbols from all R DEMODs 254a through 254r, perform MIMO detection on the received symbols if applicable, and provide detected symbols. A receive processor 258 may process (for example, decode) the detected symbols, provide decoded data for UE 120 to a data sink 260, and provide decoded control information and system information to a controller/processor 280. The term “controller/processor” may refer to one or more controllers, one or more processors, or a combination of one or more controllers and one or more processors. A channel processor may determine one or more of a reference signal received power (RSRP) parameter, a received signal strength indicator (RSSI) parameter, a reference signal received quality (RSRQ) parameter, or a channel quality indicator (CQI) parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (such as antennas 234a through 234t or antennas 252a through 252r) may include, or may be included within, one or more antenna panels, antenna groups, sets of antenna elements, or antenna arrays, among other examples. An antenna panel, an antenna group, a set of antenna elements, or an antenna array may include one or more antenna elements. An antenna panel, an antenna group, a set of antenna elements, or an antenna array may include a set of coplanar antenna elements or a set of non-coplanar antenna elements. An antenna panel, an antenna group, a set of antenna elements, or an antenna array may include antenna elements within a single housing or antenna elements within multiple housings. An antenna panel, an antenna group, a set of antenna elements, or an antenna array may include one or more antenna elements coupled to one or more transmission or reception components, such as one or more components of FIG. 2.

On the uplink, at UE 120, a transmit processor 264 may receive and process data from a data source 262 as well as control information (for example, for reports including RSRP, RSSI, RSRQ, or CQI) from controller/processor 280. Transmit processor 264 may also generate reference symbols for one or more reference signals. The symbols from transmit processor 264 may be precoded by a TX MIMO processor 266 if applicable, further processed by MODs 254a through 254r (for example, for discrete Fourier transform spread orthogonal frequency division multiplexing (DFT-s-OFDM) or orthogonal frequency division multiplexing (OFDM) with a cyclic prefix (CP) (CP-OFDM)), and transmitted to base station 110. In some aspects, a modulator and a demodulator (for example, MOD/DEMOD 254) of the UE 120 may be included in a modem of the UE 120. In some aspects, the UE 120 includes a transceiver. The transceiver may include any combination of antenna(s) 252, modulators 254, demodulators 254, MIMO detector 256, receive processor 258, transmit processor 264, or TX MIMO processor 266. The transceiver may be used by a processor (for example, controller/processor 280) and memory 282 to perform aspects of any of the methods described herein.

At base station 110, the uplink signals from UE 120 and other UEs may be received by antennas 234, processed by DEMODs 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and uplink communications. In some aspects, a modulator and a demodulator (for example, MOD/DEMOD 232) of the base station 110 may be included in a modem of the base station 110. In some aspects, the base station 110 includes a transceiver. The transceiver may include any combination of antenna(s) 234, modulators 232, demodulators 232, MIMO detector 236, receive processor 238, transmit processor 220, or TX MIMO processor 230. The transceiver may be used by a processor (for example, controller/processor 240) and memory 242 to perform aspects of any of the methods described herein.

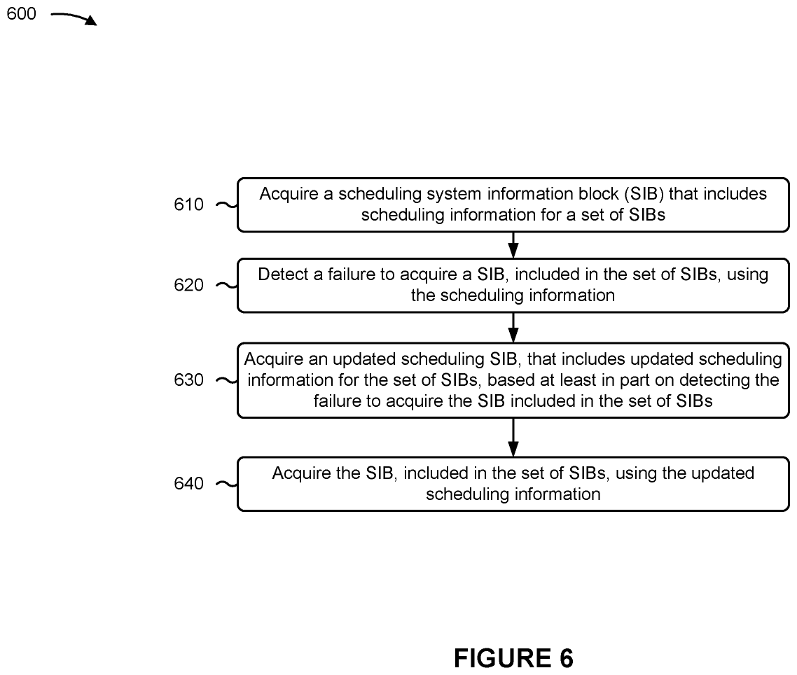

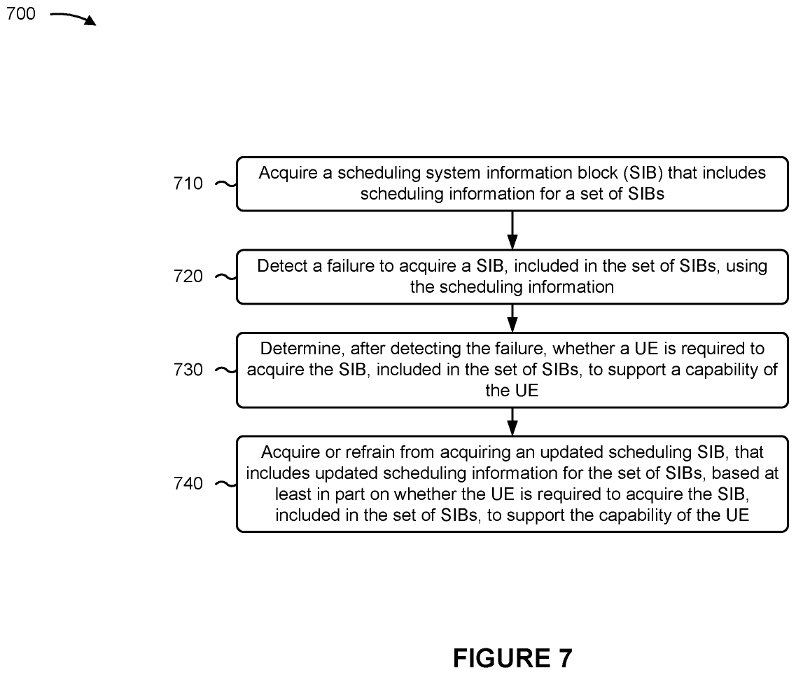

Controller/processor 240 of base station 110, controller/processor 280 of UE 120, or any other component(s) of FIG. 2 may perform one or more techniques associated with SIB reacquisition after system information schedule modification, as described in more detail elsewhere herein. For example, controller/processor 240 of base station 110, controller/processor 280 of UE 120, or any other component(s) of FIG. 2 may perform or direct operations of, for example, process 600 of FIG. 6, process 700 of FIG. 7, or other processes as described herein. Memories 242 and 282 may store data and program codes for base station 110 and UE 120, respectively. In some aspects, memory 242 or memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6, process 700 of FIG. 7, or other processes as described herein. In some aspects, executing instructions may include running the instructions, converting the instructions, compiling the instructions, or interpreting the instructions, among other examples.

In some aspects, the UE includes means for acquiring a scheduling SIB that includes scheduling information for a set of SIBs; means for detecting a failure to acquire a SIB, included in the set of SIBs, using the scheduling information; means for acquiring an updated scheduling SIB, that includes updated scheduling information for the set of SIBs, based at least in part on detecting the failure to acquire the SIB included in the set of SIBs; or means for acquiring the SIB, included in the set of SIBs, using the updated scheduling information. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282. In some aspects, the UE includes means for determining, based at least in part on information stored by the UE, that the UE is required to acquire the SIB, included in the set of SIBs, to support a capability of the UE; and means for acquiring the updated scheduling SIB based at least in part on determining that the UE is required to acquire the SIB, included in the set of SIBs, to support the capability of the UE.

In some aspects, the UE includes means for acquiring a scheduling SIB that includes scheduling information for a set of SIBs; means for detecting a failure to acquire a SIB, included in the set of SIBs, using the scheduling information; means for determining, after detecting the failure, whether the UE is required to acquire the SIB, included in the set of SIBs, to support a capability of the UE; or means for acquiring or refraining from acquiring an updated scheduling SIB, that includes updated scheduling information for the set of SIBs, based at least in part on whether the UE is required to acquire the SIB, included in the set of SIBs, to support the capability of the UE. The means for the user equipment (UE) to perform operations described herein may include, for example, one or more of antenna 252, demodulator 254, MIMO detector 256, receive processor 258, transmit processor 264, TX MIMO processor 266, modulator 254, controller/processor 280, or memory 282. In some aspects, the UE includes means for acquiring the SIB included in the set of SIBs based at least in part on the updated scheduling information.

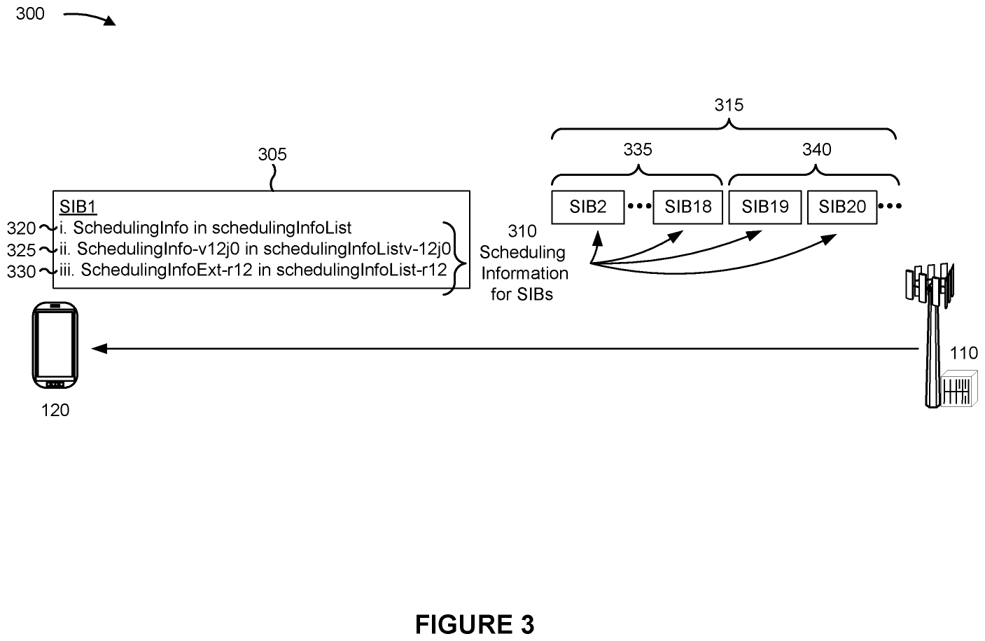

FIG. 3 is a diagram illustrating an example 300 of SIB scheduling in accordance with the present disclosure. As shown in FIG. 3, a UE 120 and a base station 110 may communicate with one another. For example, the base station 110 may transmit SIBs, and the UE 120 may acquire the SIBs.

As shown in FIG. 3, the base station 110 may transmit a scheduling SIB 305, which is shown as SIB1 in FIG. 3. The scheduling SIB 305 may include scheduling information 310 that schedules a set of SIBs 315 (for example, a set of SIBs other than SIB1, shown as SIB2 through SIB20+). As shown, the scheduling information 310 may be indicated using a first information element (IE) 320 (shown as SchedulingInfo), a second IE 325 (shown as SchedulingInfo-v12j0), a third IE 330 (shown as SchedulingInfoExt-r12), or a combination thereof. The UE 120 may use this scheduling information 310 to monitor for, acquire, obtain, or receive the set of SIBs 315.

In some examples, different SIBs, included in the set of SIBs 315, may be scheduled using different IEs. For example, a first subset of SIBs 335, included in the set of SIBs 315, may be scheduled using the first IE 320, and a second subset of SIBs 340, included in the set of SIBs 315, may be scheduled using the second IE 325, the third IE 330, or a combination thereof. In FIG. 3, the first subset of SIBs 335 includes SIB2 through SIB18 (for example, SIB2, SIB3, SIB4, SIB5, SIB6, SIB7, SIB8, SIB9, SIB10, SIB11, SIB12, SIB13, SIB14, SIB15, SIB16, SIB17, and SIB18), and the second subset of SIBs 340 includes SIB19 and above (for example, SIB19, SIB20, SIB21, SIB22, SIB23, SIB24, and so on). When the second subset of SIBs 340 (for example, SIB19 and above) are scheduled using the first IE 320, some legacy UEs cannot handle the SIB message correctly, and thus may be unable to acquire SIB1 and may consider a cell, via which SIB1 is broadcast, to be barred or may experience other stability issues. As a result, the second IE 325 and the third IE 330 were introduced for scheduling of the second subset of SIBs 340.

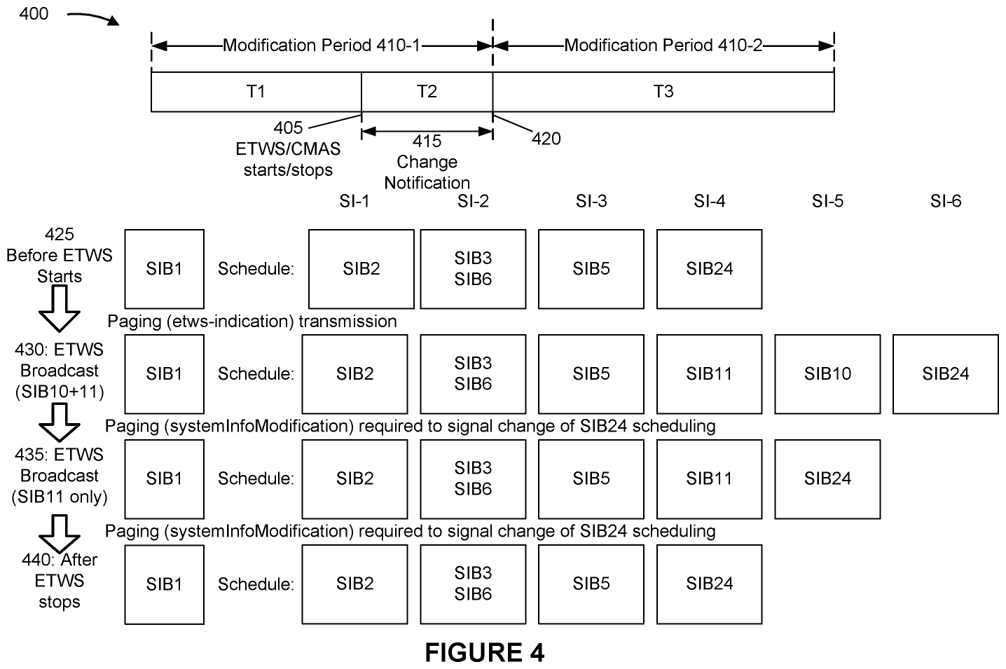

FIG. 4 is a diagram illustrating an example 400 of SIB scheduling in accordance with the present disclosure. A base station 110 may transmit a group of SIBs one or more times during a modification period (for example, a time period). Within a particular modification period, the base station 110 must transmit the same version of system information, except for system information relating to an earthquake and tsunami warning system (ETWS) message or a commercial mobile alert system (CMAS) message (for example, system information that indicates the presence of an ETWS message or a CMAS message, system information that schedules an ETWS message or a CMAS message, or system information that includes content of an ETWS message or a CMAS message). In other words, if the base station 110 transmits a particular SIB more than once in a modification period (for example, transmits SIB1 multiple times, transmits SIB2 multiple times, and so on), the content of that particular SIB is not permitted to change across those multiple transmissions within the modification period, except for SIB content relating to an ETWS message or a CMAS message. The content of a particular SIB is permitted to change across modification periods. Because ETWS and CMAS messages convey important and urgent information (for example, relating to natural disasters or other emergencies), a base station 110 is permitted to modify SIB content relating to ETWS and CMAS messages within a modification period to reduce delays in transmitting ETWS and CMAS messages. In some aspects, SIB 10 and SIB 11 may carry system information relating to an ETWS message, and SIB12 may carry information relating to a CMAS message.

When transmission of an ETWS message or a CMAS message starts or stops, the base station 110 may update SIB1 to add or remove scheduling information for one or more SIBs relating to the ETWS message (for example, to schedule SIB10, SIB11, or both) or for one or more SIBs relating to the CMAS message (for example, to schedule SIB12), and may also start or stop transmission of those SIB(s). A change to scheduling and transmission of the SIBs relating to ETWS/CMAS messages may impact (for example, may cause the base station 110 to modify) the scheduling and transmission of one or more other SIBs, such as the second subset of SIBs 340 described above in connection with FIG. 3 (for example, SIB19 and above). If a UE 120 reads SIB1 to obtain scheduling information for the second subset of SIBs 340, and then ETWS/CMAS transmission starts or stops after the UE 120 reads SIB1 and before the UE 120 acquires one or more impacted SIBs included in the second subset of SIBs 340, then the UE 120 may be unable to acquire the one or more impacted SIBs. For example, the UE 120 may attempt to acquire the impacted SIB(s) in a location (for example, a time-frequency location) in which the impacted SIB(s) are no longer transmitted (for example, due to a SIB schedule modification).

When the UE 120 fails to acquire a SIB, the UE 120 may experience performance degradation or may be unable to use one or more UE capabilities. For example, SIB19 may carry sidelink information without which the UE 120 may be unable to communicate on a sidelink. As another example, SIB20 may carry multicast or broadcast control information without which the UE 120 may be unable to receive multicast or broadcast communications. As another example, SIB21 may carry V2X (for example, cellular V2X (CV2X)) information without which the UE 120 may be unable to communicate using V2X. As another example, SIB24 may carry inter-RAT neighbor cell information for cell reselection without which the UE 120 may be unable to perform cell reselection for LTE to NR inter-RAT mobility, thereby rendering the UE 120 unable to use 5G coverage. Thus, the failure to acquire one or more SIBs due to changes to ETWS/CMAS message transmission may negatively impact functionality of the UE 120.

In example 400 of FIG. 4, transmission of an ETWS or CMAS (ETWS/CMAS) message may start or stop at a time 405 within a first modification period 410-1. The base station 110 may transmit a change notification 415 to the UE 120 to indicate the modification of system information due to the change in transmission (for example, starting or stopping) of the ETWS/CMAS message. However, the change notification 415 indicates to the UE 120 that the system information will change at the next modification period boundary, shown as a time 420 in FIG. 4, and the UE 120 will not obtain an updated SIB1 until the second modification period 410-2. As a result, if the UE 120 acquires SIB1 in a time period shown as T1 (for example, prior to the time 405) and then attempts to acquire a SIB (for example, SIB19 or above), that has been rescheduled by the base station 110, in a time period shown as T2 (for example, after the time 405 and before the time 420), then the UE 120 will fail to acquire that SIB because the SIB has been scheduled in a new resource (for example, a time domain resource) and the UE 120 attempts to obtain the SIB in an old resource (for example, according to an outdated schedule).

As a more specific example, at a time 425 before ETWS message transmission starts, SIB1 may indicate a first schedule in which SIB24 is scheduled in a time domain resource (for example, a frame, a subframe, a slot, a mini-slot, or a set of symbols) shown as SI-4. Transmission of the ETWS message may be triggered at a time 430. As a result, the base station 110 may schedule transmission of SIB11 in SI-4, may schedule transmission of SIB10 in SI-5, and may reschedule SIB24 to SI-6. The base station 110 may also indicate a second schedule in SIB1 in which SIB24 is scheduled in SI-6. If the UE 120 attempts to acquire SIB24 after time 430 using the first schedule, then the UE 120 will fail to acquire SIB24 because the UE 120 will read SI-4, where SIB24 is no longer present. Continuing with this example, transmission of the ETWS message may change at a time 435 to remove SIB 10 and transmit only SIB11, resulting in another schedule change that impacts SIB24, which may also lead to the UE 120 failing to acquire SIB24. As further shown, ETWS transmission may stop at a time 440, and the base station 110 may reschedule SIB24 back to SI-4. If the UE 120 attempts to acquire SIB24 after time 440 using the second schedule, then the UE 120 will fail to acquire SIB24 because the UE 120 will read SI-6, where SIB24 is no longer present. Thus, when transmission of an ETWS message or a CMAS message begins or ends, the UE 120 may fail to acquire one or more SIBs due to a schedule change of which the UE 120 has not been notified (in an example where the base station 110 does not notify the UE 120 of the end of the transmission) or which the UE 120 does not apply until a next modification period (in an example where the base station 110 notifies the UE 120 of the start or end of the transmission using the change notification 415).

Various aspects relate generally to SIB reacquisition after system information schedule modification. Some aspects more specifically relate to enabling a UE to reacquire SIB1 after failing to acquire a SIB scheduled by SIB1. In some aspects, the UE may obtain updated SIB scheduling information in the reacquired SIB1, and may use that updated SIB scheduling information to reacquire the SIB that the UE previously failed to acquire. In some aspects, the SIB that the UE fails to acquire may be SIB19 or above. In some aspects, the failure of the UE to acquire the SIB may be due to a beginning or an end of transmission of an ETWS message or a CMAS message. In some aspects, the UE may only reacquire SIB1 or the failed SIB if the UE is required to obtain the failed SIB to support a capability of the UE.

Particular aspects of the subject matter described in this disclosure can be implemented to realize one or more of the following potential advantages. In some examples, the described techniques can be used to acquire a SIB, that supports a capability of the UE, that the UE would otherwise be unable to timely acquire. In some examples, the described techniques reduce communication errors and conserve resources of the UE (for example, memory resources or processing resources) that would otherwise be used in a failed attempt to acquire the SIB in an outdated time domain resource. In some examples, the described techniques enable the UE to acquire an emergency notification, such as an ETWS notification or a CMAS notification, without a loss of functionality relating to content carried in a SIB that is rescheduled due to the emergency notification.

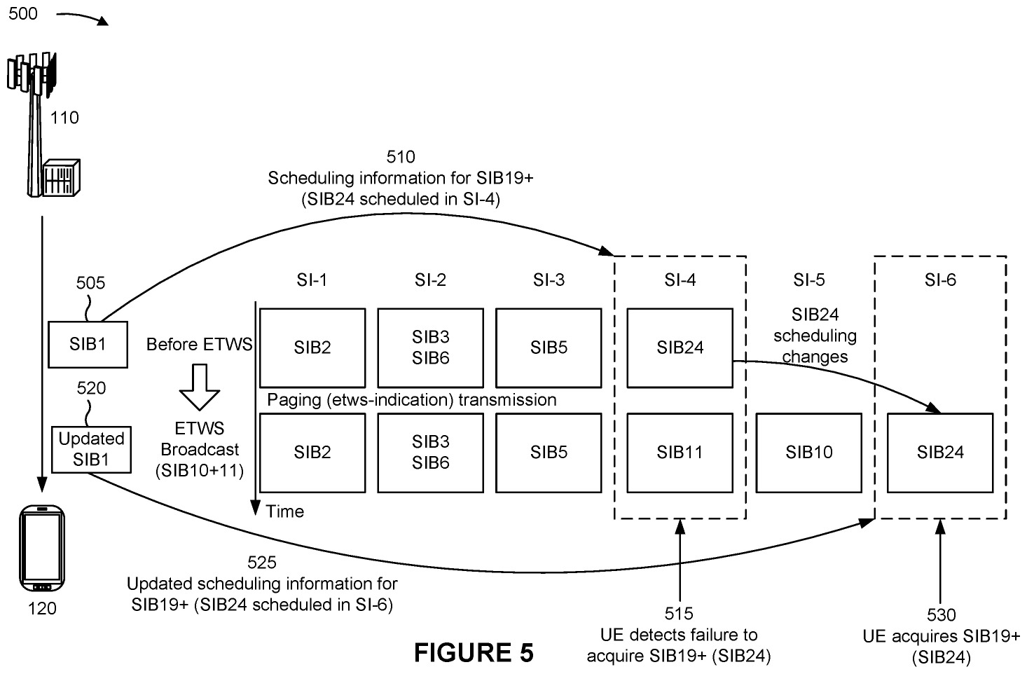

FIG. 5 is a diagram illustrating an example 500 associated with SIB reacquisition after system information schedule modification in accordance with the present disclosure. As shown in FIG. 5, a UE 120 and a base station 110 may communicate with one another.

As shown in FIG. 5, the UE 120 may acquire a scheduling SIB 505 that includes scheduling information 510 for a set of SIBs. In some aspects, the scheduling SIB 505 is SIB1, and the set of SIBs includes a set of SIBs other than SIB1 (for example, all SIBs other than SIB1), as described above in connection with FIG. 3. As also described above in connection with FIG. 3, the scheduling information 510 may be indicated in the scheduling SIB 505 using a first IE (such as a SchedulingInfo IE), a second IE (such as a SchedulingInfo-v12j0 IE), a third IE (such as a SchedulingInfoExt-r12 IE), or a combination thereof. The UE 120 may use the scheduling information 510 to monitor for, acquire, obtain, or receive the set of SIBs. As also described above in connection with FIG. 3, different SIBs, included in the set of SIBs scheduled by the scheduling SIB 505, may be scheduled using different IEs. For example, a first subset of SIBs (for example, SIB2 through SIB18), included in the set of SIBs, may be scheduled using the first IE. Additionally or alternatively, a second subset of SIBs (for example, SIB19 and above, or a subset of SIBs that excludes SIB18 and below), included in the set of SIBs, may be scheduled using the second IE, the third IE, or a combination thereof.

In an operation 515, the UE 120 may detect a failure to acquire (for example, a failure to obtain, read, receive, or decode) a SIB, included in the set of SIBs, using the scheduling information 510. In some aspects, the UE 120 may detect a failure to acquire a SIB included in the second subset of SIBs that are scheduled using the second IE or the third IE of the scheduling information 510. As another example, the UE 120 may detect a failure to acquire a SIB, scheduled by the scheduling information 510 having a SIB index that is greater than or equal to a threshold, such as 19. For example, the UE 120 may detect a failure to acquire SIB19 or above (for example, SIB19, SIB20, SIB21, SIB22, SIB23, SIB24, and so on). In some aspects, the UE 120 may use the scheduling information 510 to determine a resource (for example, a time domain resource, a frequency domain resource, a spatial domain resource, or a combination thereof) in which the SIB is scheduled. The UE 120 may attempt to acquire the SIB in that resource and may determine that the attempted acquisition has failed, such as due to a decoding failure, a failure of a cyclic redundancy check, or another type of failure that results in the UE 120 being unable to read content of the SIB.

Based at least in part on detecting the failure to acquire the SIB, the UE 120 may acquire an updated scheduling SIB 520. The updated scheduling SIB 520 may be an updated SIB1, and may include updated scheduling information 525. Thus, the scheduling SIB 505 may be a first SIB1, and the updated scheduling SIB 520 may be a second SIB1 that is transmitted at a later time than the first SIB1. In other words, the scheduling SIB 505 and the updated scheduling SIB 520 may be the same type of SIB, but may carry different content (for example, different scheduling information).

As shown, the updated scheduling SIB 520 may include updated scheduling information 525 that schedules a set of SIBs other than SIB1 (for example, all SIBs other than SIB1). The updated scheduling information 525 may be indicated in the updated scheduling SIB 520 using a first IE (such as a SchedulingInfo IE), a second IE (such as a SchedulingInfo-v12j0 IE), a third IE (such as a SchedulingInfoExt-r12 IE), or a combination thereof. In some aspects, the first IE in the updated scheduling SIB 520 may carry the same information as the first IE in the scheduling SIB 505 (for example, for scheduling of SIB2 through SIB18). In some aspects, the second IE in the updated scheduling SIB 520 may carry different information that the second IE in the scheduling SIB 505, or the third IE in the updated scheduling SIB 520 may carry different information that the third IE in the scheduling SIB 505 (for example, for scheduling of SIB19 and above). Thus, the scheduling SIB 505 and the updated scheduling SIB 520 may carry different scheduling information for scheduling the second subset of SIBs (for example, SIB19 and above, or all SIBs other than SIB18 and below).

In some aspects, the UE 120 may acquire the updated scheduling SIB 520 in a same modification period in which the UE 120 acquires the scheduling SIB 505. In some aspects, the UE 120 may acquire the updated scheduling SIB 520 in a different modification period than a modification period in which the UE 120 acquires the scheduling SIB 505. For example, the UE 120 may acquire the updated scheduling SIB 520 in the next modification period after (for example, that immediately follows) a modification period in which the UE 120 acquires the scheduling SIB 505.

In some aspects, the UE 120 may determine whether the UE 120 is required to acquire the SIB, that the UE 120 previously failed to acquire, to support a capability of the UE 120 (for example, to enable the UE 120 to use the capability). In some aspects, the UE 120 may make this determination after detecting the failure to acquire the SIB. If the UE 120 is required to acquire the SIB that the UE 120 previously failed to acquire, then the UE 120 may acquire the updated scheduling SIB 520 (and may acquire the SIB that the UE 120 previously failed to acquire, as described below). For example, the UE 120 may acquire the updated scheduling SIB 520 (and the SIB that the UE 120 previously failed to acquire) based at least in part on determining that the UE 120 is required to acquire the SIB to support a capability of the UE 120. However, if the UE 120 is not required to obtain the SIB to support a capability of the UE 120, then the UE 120 may refrain from acquiring the updated scheduling SIB 520 (for example, in the same modification period in which the UE 120 obtained the scheduling SIB 505 or failed to acquire the SIB). In this way, the UE 120 may conserve resources of the UE (for example, memory resources or processing resources) that would otherwise be used to acquire scheduling information for a SIB (and to acquire the SIB itself) that is not needed for any operations of the UE 120.

In some aspects, the UE 120 may store information, in memory, that indicates the SIB(s) required to support a capability of the UE 120, and may determine whether to acquire the updated scheduling SIB 520 based at least in part on the stored information. Additionally or alternatively, the base station 110 may signal, to the UE 120, the SIB(s) required to support a capability of the UE 120.

As an example, if the UE 120 is not capable of (or does not have a capability to support) sidelink communication, then the UE 120 may refrain from acquiring the updated scheduling SIB 525 after detecting a failure of a SIB (for example, SIB19) that carries sidelink information. As another example, if the UE 120 is not capable of (or does not have a capability to support) multicast or broadcast communication, or is not subscribed to any multicast or broadcast services, then the UE 120 may refrain from acquiring the updated scheduling SIB 525 after detecting a failure of a SIB (for example, SIB20) that carries multicast or broadcast control information. As another example, if the UE 120 is not capable of (or does not have a capability to support) V2X (or CV2X) communication, then the UE 120 may refrain from acquiring the updated scheduling SIB 525 after detecting a failure of a SIB (for example, SIB21) that carries V2X (or CV2X) information. As another example, if the UE 120 is not capable of (or does not have a capability to support) NR standalone communication, then the UE 120 may refrain from acquiring the updated scheduling SIB 525 after detecting a failure of a SIB (for example, SIB24) that carries information for NR standalone communication.

In an operation 530, the UE 120 may acquire (for example, obtain, read, receive, or decode) the SIB, that the UE 120 previously failed to acquire, using the updated scheduling information 525. In some aspects, the UE 120 may use the updated scheduling information 525 to determine a resource (for example, a time domain resource, a frequency domain resource, a spatial domain resource, or a combination thereof) in which the SIB is scheduled. The UE 120 may acquire the SIB in that resource.

FIG. 6 is a flowchart illustrating an example process 600 performed, for example, by a UE that supports SIB reacquisition after system information schedule modification in accordance with the present disclosure. Example process 600 is an example where the UE (for example, UE 120) performs operations associated with SIB reacquisition after system information schedule modification.

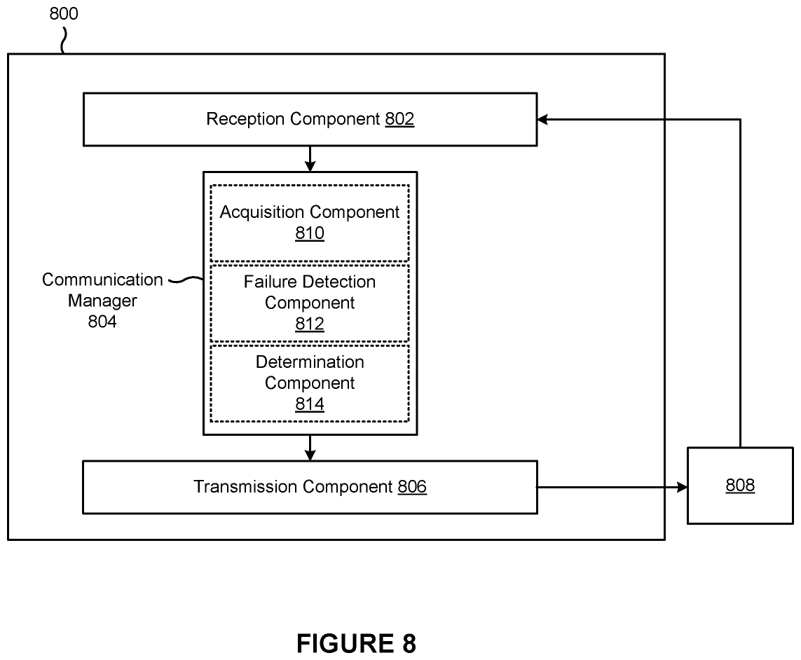

As shown in FIG. 6, in some aspects, process 600 may include acquiring a scheduling SIB that includes scheduling information for a set of SIBs (block 610). For example, the UE (such as by using reception component 802 or acquisition component 810, depicted in FIG. 8) may acquire a scheduling SIB that includes scheduling information for a set of SIBs, as described above.

As further shown in FIG. 6, in some aspects, process 600 may include detecting a failure to acquire a SIB, included in the set of SIBs, using the scheduling information (block 620). For example, the UE (such as by using failure detection component 812, depicted in FIG. 8) may detect a failure to acquire a SIB, included in the set of SIBs, using the scheduling information, as described above.

As further shown in FIG. 6, in some aspects, process 600 may include acquiring an updated scheduling SIB, that includes updated scheduling information for the set of SIBs, based at least in part on detecting the failure to acquire the SIB included in the set of SIBs (block 630). For example, the UE (such as by using reception component 802 or acquisition component 810, depicted in FIG. 8) may acquire an updated scheduling SIB, that includes updated scheduling information for the set of SIBs, based at least in part on detecting the failure to acquire the SIB included in the set of SIBs, as described above.

As further shown in FIG. 6, in some aspects, process 600 may include acquiring the SIB, included in the set of SIBs, using the updated scheduling information (block 640). For example, the UE (such as by using reception component 802 or acquisition component 810, depicted in FIG. 8) may acquire the SIB, included in the set of SIBs, using the updated scheduling information, as described above.

Process 600 may include additional aspects, such as any single aspect or any combination of aspects described below or in connection with one or more other processes described elsewhere herein.

In a first additional aspect, the updated scheduling SIB is acquired in a same modification period in which the scheduling SIB is acquired.

In a second additional aspect, alone or in combination with the first aspect, the updated scheduling SIB is acquired in a modification period that immediately follows a modification period in which the scheduling SIB is acquired.

In a third additional aspect, alone or in combination with one or more of the first and second aspects, the scheduling SIB is a SIB1 and the updated scheduling SIB is another SIB1.

In a fourth additional aspect, alone or in combination with one or more of the first through third aspects, the SIB is SIB19 or above.

In a fifth additional aspect, alone or in combination with one or more of the first through fourth aspects, the SIB is included in a subset of SIBs, of the set of SIBs, that excludes SIB18 and below.

In a sixth additional aspect, alone or in combination with one or more of the first through fifth aspects, process 600 includes determining, based at least in part on information stored by the UE, that the UE is required to acquire the SIB, included in the set of SIBs, to support a capability of the UE, and wherein acquiring the updated scheduling SIB comprises acquiring the updated scheduling SIB based at least in part on determining that the UE is required to acquire the SIB, included in the set of SIBs, to support the capability of the UE.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, by an UE that supports SIB reacquisition after system information schedule modification in accordance with the present disclosure. Example process 700 is an example where the UE (for example, UE 120) performs operations associated with SIB reacquisition after system information schedule modification.

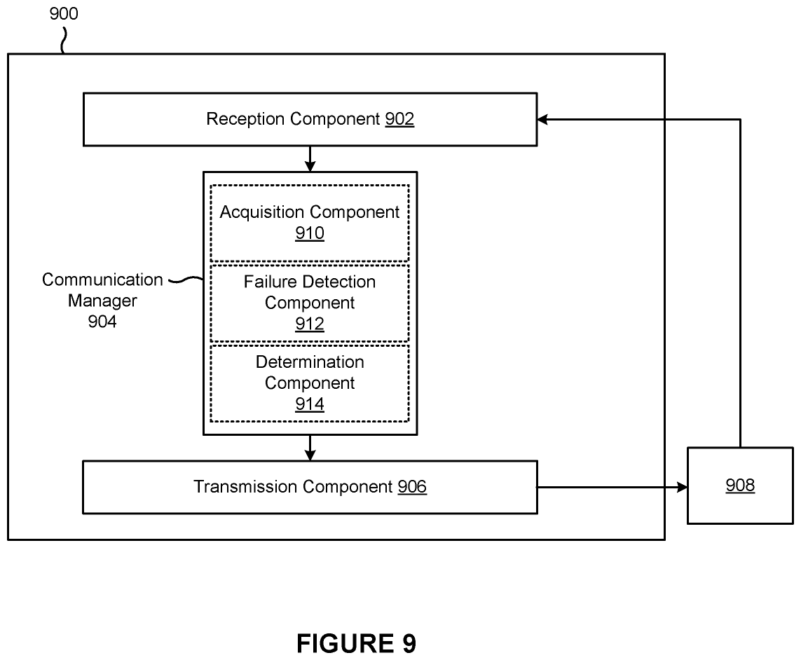

As shown in FIG. 7, in some aspects, process 700 may include acquiring a scheduling SIB that includes scheduling information for a set of SIBs (block 710). For example, the UE (such as by using reception component 902 or acquisition component 910, depicted in FIG. 9) may acquire a scheduling SIB that includes scheduling information for a set of SIBs, as described above.

As further shown in FIG. 7, in some aspects, process 700 may include detecting a failure to acquire a SIB, included in the set of SIBs, using the scheduling information (block 720). For example, the UE (such as by using failure detection component 912, depicted in FIG. 9) may detect a failure to acquire a SIB, included in the set of SIBs, using the scheduling information, as described above.

As further shown in FIG. 7, in some aspects, process 700 may include determining, after detecting the failure, whether the UE is required to acquire the SIB, included in the set of SIBs, to support a capability of the UE (block 730). For example, the UE (such as by using determination component 914, depicted in FIG. 9) may determine, after detecting the failure, whether the UE is required to acquire the SIB, included in the set of SIBs, to support a capability of the UE, as described above.

As further shown in FIG. 7, in some aspects, process 700 may include acquiring or refraining from acquiring an updated scheduling SIB, that includes updated scheduling information for the set of SIBs, based at least in part on whether the UE is required to acquire the SIB, included in the set of SIBs, to support the capability of the UE (block 740). For example, the UE (such as by using reception component 902 or acquisition component 910, depicted in FIG. 9) may acquire or refraining from acquiring an updated scheduling SIB, that includes updated scheduling information for the set of SIBs, based at least in part on whether the UE is required to acquire the SIB, included in the set of SIBs, to support the capability of the UE, as described above.

Process 700 may include additional aspects, such as any single aspect or any combination of aspects described below or in connection with one or more other processes described elsewhere herein.

In a first additional aspect, acquiring or refraining from acquiring the updated scheduling SIB comprises refraining from acquiring the updated scheduling SIB based at least in part on a determination that the UE is not required to acquire the SIB, included in the set of SIBs, to support the capability of the UE.

In a second additional aspect, alone or in combination with the first aspect, acquiring or refraining from acquiring the updated scheduling SIB comprises acquiring the updated scheduling SIB based at least in part on a determination that the UE is required to acquire the SIB, included in the set of SIBs, to support the capability of the UE.

In a third additional aspect, alone or in combination with one or more of the first and second aspects, process 700 includes acquiring the SIB included in the set of SIBs based at least in part on the updated scheduling information.

In a fourth additional aspect, alone or in combination with one or more of the first through third aspects, the updated scheduling SIB is acquired in a same modification period in which the scheduling SIB is acquired.

In a fifth additional aspect, alone or in combination with one or more of the first through fourth aspects, the updated scheduling SIB is acquired in a modification period that immediately follows a modification period in which the scheduling SIB is acquired.

In a sixth additional aspect, alone or in combination with one or more of the first through fifth aspects, the scheduling SIB is SIB1 and the updated scheduling SIB is SIB1.

In a seventh additional aspect, alone or in combination with one or more of the first through sixth aspects, the SIB is SIB19 or above.

In an eighth additional aspect, alone or in combination with one or more of the first through seventh aspects, the SIB is included in a subset of SIBs, of the set of SIBs, that excludes SIB18 and below.

In a ninth additional aspect, alone or in combination with one or more of the first through eighth aspects, determining whether the UE is required to acquire the SIB included in the set of SIBs comprises determining whether the UE is required to acquire the SIB included in the set of SIBs based at least in part on information stored in memory of the UE.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a block diagram of an example apparatus 800 for wireless communication that support SIB reacquisition after system information schedule modification in accordance with the present disclosure. The apparatus 800 may be a UE, or a UE may include the apparatus 800. In some aspects, the apparatus 800 includes a reception component 802, a communication manager 804, and a transmission component 806, which may be in communication with one another (for example, via one or more buses). As shown, the apparatus 800 may communicate with another apparatus 808 (such as a UE, a base station, or another wireless communication device) using the reception component 802 and the transmission component 806.

In some aspects, the apparatus 800 may be configured to perform one or more operations described herein in connection with FIG. 5. Additionally or alternatively, the apparatus 800 may be configured to perform one or more processes described herein, such as process 600 of FIG. 6, process 700 of FIG. 7, or a combination thereof. In some aspects, the apparatus 800 may include one or more components of the UE described above in connection with FIG. 2.

The reception component 802 may receive communications, such as reference signals, control information, data communications, or a combination thereof, from the apparatus 808. The reception component 802 may provide received communications to one or more other components of the apparatus 800, such as the communication manager 804. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a demodulator, a MIMO detector, a receive processor, a controller/processor, a memory, or a combination thereof, of the UE described above in connection with FIG. 2.

The transmission component 806 may transmit communications, such as reference signals, control information, data communications, or a combination thereof, to the apparatus 808. In some aspects, the communication manager 804 may generate communications and may transmit the generated communications to the transmission component 806 for transmission to the apparatus 808. In some aspects, the transmission component 806 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 806 may include one or more antennas, a modulator, a transmit MIMO processor, a transmit processor, a controller/processor, a memory, or a combination thereof, of the UE described above in connection with FIG. 2. In some aspects, the transmission component 806 may be co-located with the reception component 802 in a transceiver.

The communication manager 804 may acquire a scheduling SIB that includes scheduling information for a set of SIBs. The communication manager 804 may detect a failure to acquire a SIB, included in the set of SIBs, using the scheduling information. The communication manager 804 may acquire an updated scheduling SIB, that includes updated scheduling information for the set of SIBs, based at least in part on detecting the failure to acquire the SIB included in the set of SIBs. The communication manager 804 may acquire the SIB, included in the set of SIBs, using the updated scheduling information. In some aspects, the communication manager 804 may perform one or more operations described elsewhere herein as being performed by one or more components of the communication manager 804.

The communication manager 804 may include a controller/processor, a memory, or a combination thereof, of the UE described above in connection with FIG. 2. In some aspects, the communication manager 804 includes a set of components, such as an acquisition component 810, a failure detection component 812, a determination component 814, or a combination thereof. Alternatively, the set of components may be separate and distinct from the communication manager 804. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 or the acquisition component 810 may acquire a scheduling SIB that includes scheduling information for a set of SIBs. The failure detection component 812 may detect a failure to acquire a SIB, included in the set of SIBs, using the scheduling information. The reception component 802 or the acquisition component 810 may acquire an updated scheduling SIB, that includes updated scheduling information for the set of SIBs, based at least in part on detecting the failure to acquire the SIB included in the set of SIBs. The reception component 802 or the acquisition component 810 may acquire the SIB, included in the set of SIBs, using the updated scheduling information. The determination component 814 may determine, based at least in part on information stored by the UE, that the UE is required to acquire the SIB, included in the set of SIBs, to support a capability of the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a block diagram of an example apparatus 900 for wireless communication that support SIB reacquisition after system information schedule modification in accordance with the present disclosure. The apparatus 900 may be a UE, or a UE may include the apparatus 900. In some aspects, the apparatus 900 includes a reception component 902, a communication manager 904, and a transmission component 906, which may be in communication with one another (for example, via one or more buses). As shown, the apparatus 900 may communicate with another apparatus 908 (such as a UE, a base station, or another wireless communication device) using the reception component 902 and the transmission component 906.

In some aspects, the apparatus 900 may be configured to perform one or more operations described herein in connection with FIG. 5. Additionally or alternatively, the apparatus 900 may be configured to perform one or more processes described herein, such as process 600 of FIG. 6, process 700 of FIG. 7, or a combination thereof. In some aspects, the apparatus 900 may include one or more components of the UE described above in connection with FIG. 2.

The reception component 902 may receive communications, such as reference signals, control information, data communications, or a combination thereof, from the apparatus 908. The reception component 902 may provide received communications to one or more other components of the apparatus 900, such as the communication manager 904. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a demodulator, a MIMO detector, a receive processor, a controller/processor, a memory, or a combination thereof, of the UE described above in connection with FIG. 2.

The transmission component 906 may transmit communications, such as reference signals, control information, data communications, or a combination thereof, to the apparatus 908. In some aspects, the communication manager 904 may generate communications and may transmit the generated communications to the transmission component 906 for transmission to the apparatus 908. In some aspects, the transmission component 906 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 906 may include one or more antennas, a modulator, a transmit MIMO processor, a transmit processor, a controller/processor, a memory, or a combination thereof, of the UE described above in connection with FIG. 2. In some aspects, the transmission component 906 may be co-located with the reception component 902 in a transceiver.

The communication manager 904 may acquire a scheduling SIB that includes scheduling information for a set of SIBs. The communication manager 904 may detect a failure to acquire a SIB, included in the set of SIBs, using the scheduling information. The communication manager 904 may determine, after detecting the failure, whether the UE is required to acquire the SIB, included in the set of SIBs, to support a capability of the UE. The communication manager 904 may acquire or refrain from acquiring an updated scheduling SIB, that includes updated scheduling information for the set of SIBs, based at least in part on whether the UE is required to acquire the SIB, included in the set of SIBs, to support the capability of the UE. In some aspects, the communication manager 904 may perform one or more operations described elsewhere herein as being performed by one or more components of the communication manager 904.

The communication manager 904 may include a controller/processor, a memory, or a combination thereof, of the UE described above in connection with FIG. 2. In some aspects, the communication manager 904 includes a set of components, such as an acquisition component 910, a failure detection component 912, a determination component 914, or a combination thereof. Alternatively, the set of components may be separate and distinct from the communication manager 904. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 or the acquisition component 910 may acquire a scheduling SIB that includes scheduling information for a set of SIBs. The failure detection component 912 may detect a failure to acquire a SIB, included in the set of SIBs, using the scheduling information. The determination component 914 may determine, after detecting the failure, whether the UE is required to acquire the SIB, included in the set of SIBs, to support a capability of the UE. The reception component 902 or the acquisition component 910 may acquire or refrain from acquiring an updated scheduling SIB, that includes updated scheduling information for the set of SIBs, based at least in part on whether the UE is required to acquire the SIB, included in the set of SIBs, to support the capability of the UE. The reception component 902 or the acquisition component 910 may acquire the SIB included in the set of SIBs based at least in part on the updated scheduling information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some aspects of the present disclosure:

Aspect 1: A method of wireless communication performed by a user equipment (UE), comprising: acquiring a scheduling system information block (SIB) that includes scheduling information for a set of SIBs; detecting a failure to acquire a SIB, included in the set of SIBs, using the scheduling information; acquiring an updated scheduling SIB, that includes updated scheduling information for the set of SIBs, based at least in part on detecting the failure to acquire the SIB included in the set of SIBs; and acquiring the SIB, included in the set of SIBs, using the updated scheduling information.

Aspect 2: The method of aspect 1, wherein the updated scheduling SIB is acquired in a same modification period in which the scheduling SIB is acquired.

Aspect 3: The method of aspect 1, wherein the updated scheduling SIB is acquired in a modification period that immediately follows a modification period in which the scheduling SIB is acquired.

Aspect 4: The method of any of the preceding aspects, wherein the scheduling SIB is a SIB1 and the updated scheduling SIB is another SIB1.

Aspect 5: The method of any of the preceding aspects, wherein the SIB is SIB19 or above.

Aspect 6: The method of any of the preceding aspects, wherein the SIB is included in a subset of SIBs, of the set of SIBs, that excludes SIB18 and below.

Aspect 7: The method of any of the preceding aspects, further comprising: determining, based at least in part on information stored by the UE, that the UE is required to acquire the SIB, included in the set of SIBs, to support a capability of the UE; and wherein acquiring the updated scheduling SIB comprises acquiring the updated scheduling SIB based at least in part on determining that the UE is required to acquire the SIB, included in the set of SIBs, to support the capability of the UE.

Aspect 8: A method of wireless communication performed by a user equipment (UE), comprising: acquiring a scheduling system information block (SIB) that includes scheduling information for a set of SIBs; detecting a failure to acquire a SIB, included in the set of SIBs, using the scheduling information; determining, after detecting the failure, whether the UE is required to acquire the SIB, included in the set of SIBs, to support a capability of the UE; and acquiring or refraining from acquiring an updated scheduling SIB, that includes updated scheduling information for the set of SIBs, based at least in part on whether the UE is required to acquire the SIB, included in the set of SIBs, to support the capability of the UE.

Aspect 9: The method of aspect 8, wherein acquiring or refraining from acquiring the updated scheduling SIB comprises refraining from acquiring the updated scheduling SIB based at least in part on a determination that the UE is not required to acquire the SIB, included in the set of SIBs, to support the capability of the UE.

Aspect 10: The method of aspect 8, wherein acquiring or refraining from acquiring the updated scheduling SIB comprises acquiring the updated scheduling SIB based at least in part on a determination that the UE is required to acquire the SIB, included in the set of SIBs, to support the capability of the UE.

Aspect 11: The method of aspect 10, further comprising acquiring the SIB included in the set of SIBs based at least in part on the updated scheduling information.

Aspect 12: The method of any of aspects 8-11, wherein the updated scheduling SIB is acquired in a same modification period in which the scheduling SIB is acquired.

Aspect 13: The method of any of aspects 8-11, wherein the updated scheduling SIB is acquired in a modification period that immediately follows a modification period in which the scheduling SIB is acquired.

Aspect 14: The method of any of aspects 8-13, wherein the scheduling SIB is SIB1 and the updated scheduling SIB is SIB1.

Aspect 15: The method of any of aspects 8-14, wherein the SIB is SIB19 or above.

Aspect 16: The method of any of aspects 8-15, wherein the SIB is included in a subset of SIBs, of the set of SIBs, that excludes SIB18 and below.

Aspect 17: The method of any of aspects 8-16, wherein determining whether the UE is required to acquire the SIB included in the set of SIBs comprises determining whether the UE is required to acquire the SIB included in the set of SIBs based at least in part on information stored in memory of the UE.

Aspect 18: An apparatus for wireless communication at a device, comprising a processor; memory coupled with the processor; and instructions stored in the memory and executable by the processor to cause the apparatus to perform the method of one or more aspects of aspects 1-7.

Aspect 19: A device for wireless communication, comprising a memory and one or more processors coupled to the memory, the memory and the one or more processors configured to perform the method of one or more aspects of aspects 1-7.

Aspect 20: An apparatus for wireless communication, comprising at least one means for performing the method of one or more aspects of aspects 1-7.

Aspect 21: A non-transitory computer-readable medium storing code for wireless communication, the code comprising instructions executable by a processor to perform the method of one or more aspects of aspects 1-7.

Aspect 22: A non-transitory computer-readable medium storing a set of instructions for wireless communication, the set of instructions comprising one or more instructions that, when executed by one or more processors of a device, cause the device to perform the method of one or more aspects of aspects 1-7.

Aspect 23: An apparatus for wireless communication at a device, comprising a processor; memory coupled with the processor; and instructions stored in the memory and executable by the processor to cause the apparatus to perform the method of one or more aspects of aspects 8-17.

Aspect 24: A device for wireless communication, comprising a memory and one or more processors coupled to the memory, the memory and the one or more processors configured to perform the method of one or more aspects of aspects 8-17.

Aspect 25: An apparatus for wireless communication, comprising at least one means for performing the method of one or more aspects of aspects 8-17.

Aspect 26: A non-transitory computer-readable medium storing code for wireless communication, the code comprising instructions executable by a processor to perform the method of one or more aspects of aspects 8-17.

Aspect 27: A non-transitory computer-readable medium storing a set of instructions for wireless communication, the set of instructions comprising one or more instructions that, when executed by one or more processors of a device, cause the device to perform the method of one or more aspects of aspects 8-17.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have.” “having,” and similar terms are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “cither” or “only one of”).

1. A method of wireless communication performed at user equipment (UE), comprising:
acquiring a scheduling system information block (SIB) that includes scheduling information for a set of SIBs;
detecting a failure to acquire a SIB, included in the set of SIBs, using the scheduling information;
acquiring an updated scheduling SIB, that includes updated scheduling information for the set of SIBs, based at least in part on detecting the failure to acquire the SIB included in the set of SIBs; and
acquiring the SIB, included in the set of SIBs, using the updated scheduling information.

2. The method of claim 1, wherein the updated scheduling SIB is acquired in a same modification period in which the scheduling SIB is acquired.

3. The method of claim 1, wherein the updated scheduling SIB is acquired in a modification period that immediately follows a modification period in which the scheduling SIB is acquired.

4. (canceled)

5. The method of claim 1, wherein the SIB is SIB19 or above.

6. (canceled)

7. The method of claim 1, further comprising:
determining, based at least in part on information stored by the UE, that the UE is required to acquire the SIB, included in the set of SIBs, to support a capability of the UE; and
wherein acquiring the updated scheduling SIB comprises acquiring the updated scheduling SIB based at least in part on determining that the UE is required to acquire the SIB, included in the set of SIBs, to support the capability of the UE.

8. A method of wireless communication performed at a user equipment (UE), comprising:
acquiring a scheduling system information block (SIB) that includes scheduling information for a set of SIBs;
detecting a failure to acquire a SIB, included in the set of SIBs, using the scheduling information;
determining, after detecting the failure, whether the UE is required to acquire the SIB, included in the set of SIBs, to support a capability of the UE; and
acquiring or refraining from acquiring an updated scheduling SIB, that includes updated scheduling information for the set of SIBs, based at least in part on whether the UE is required to acquire the SIB, included in the set of SIBs, to support the capability of the UE.

9. The method of claim 8, wherein acquiring or refraining from acquiring the updated scheduling SIB comprises refraining from acquiring the updated scheduling SIB based at least in part on a determination that the UE is not required to acquire the SIB, included in the set of SIBs, to support the capability of the UE.

10. The method of claim 8, wherein acquiring or refraining from acquiring the updated scheduling SIB comprises acquiring the updated scheduling SIB based at least in part on a determination that the UE is required to acquire the SIB, included in the set of SIBs, to support the capability of the UE.

11. The method of claim 10, further comprising acquiring the SIB included in the set of SIBs based at least in part on the updated scheduling information.

12. The method of claim 8, wherein the updated scheduling SIB is acquired in a same modification period in which the scheduling SIB is acquired.

13. The method of claim 8, wherein the updated scheduling SIB is acquired in a modification period that immediately follows a modification period in which the scheduling SIB is acquired.

14. (canceled)

15. The method of claim 8, wherein the SIB is SIB19 or above.

16. (canceled)

17. The method of claim 8, wherein determining whether the UE is required to acquire the SIB included in the set of SIBs comprises determining whether the UE is required to acquire the SIB included in the set of SIBs based at least in part on information stored in memory of the UE.

18. A user equipment (UE) for wireless communication, comprising:
one or more memories storing processor-readable code; and
one or more processors coupled with the one or more memories and individually or collectively operable to cause the UE to:
acquire a scheduling system information block (SIB) that includes scheduling information for a set of SIBs;
detect a failure to acquire a SIB, included in the set of SIBs, using the scheduling information;
acquire an updated scheduling SIB, that includes updated scheduling information for the set of SIBs, based at least in part on detecting the failure to acquire the SIB included in the set of SIBs; and
acquire the SIB, included in the set of SIBs, using the updated scheduling information.

19. The UE of claim 18, wherein the updated scheduling SIB is acquired in a same modification period in which the scheduling SIB is acquired.

20. The UE of claim 18, wherein the updated scheduling SIB is acquired in a modification period that immediately follows a modification period in which the scheduling SIB is acquired.

21. The UE of claim 18, wherein the scheduling SIB is a SIB1 and the updated scheduling SIB is another SIB1.

22. The UE of claim 18, wherein the SIB is SIB19 or above.

23. The UE of claim 18, wherein the SIB is included in a subset of SIBs, of the set of SIBs, that excludes SIB18 and below.

24. The UE of claim 18, wherein the one or more processors are operable to cause the UE to:
determine, based at least in part on information stored by the UE, that the UE is required to acquire the SIB, included in the set of SIBs, to support a capability of the UE; and
wherein, to cause the UE to acquire the updated scheduling SIB, the one or more processors are operable to cause the UE to acquire the updated scheduling SIB based at least in part on determining that the UE is required to acquire the SIB, included in the set of SIBs, to support the capability of the UE.

25. A user equipment (UE) for wireless communication, comprising:
one or more memories storing processor-readable code; and
one or more processors coupled with one or more memories and individually or collectively operable to cause the UE to:
acquire a scheduling system information block (SIB) that includes scheduling information for a set of SIBs;
detect a failure to acquire a SIB, included in the set of SIBs, using the scheduling information;
determine, after detecting the failure, whether the UE is required to acquire the SIB, included in the set of SIBs, to support a capability of the UE; and
acquire or refrain from acquiring an updated scheduling SIB, that includes updated scheduling information for the set of SIBs, based at least in part on whether the UE is required to acquire the SIB, included in the set of SIBs, to support the capability of the UE.

26. The UE of claim 25, wherein, to cause the UE to acquire or refrain from acquiring the updated scheduling SIB, the one or more processors are operable to cause the UE to refrain from acquiring the updated scheduling SIB based at least in part on a determination that the UE is not required to acquire the SIB, included in the set of SIBs, to support the capability of the UE.

27. The UE of claim 25, wherein, to cause the UE to acquire or refrain from acquiring the updated scheduling SIB, the one or more processors are operable to cause the UE to acquire the updated scheduling SIB based at least in part on a determination that the UE is required to acquire the SIB, included in the set of SIBs, to support the capability of the UE.

28. The UE of claim 27, wherein the one or more processors are operable to cause the UE to acquire the SIB included in the set of SIBs based at least in part on the updated scheduling information.

29. The UE of claim 25, wherein the updated scheduling SIB is acquired in a same modification period in which the scheduling SIB is acquired.

30. The UE of claim 25, wherein the updated scheduling SIB is acquired in a modification period that immediately follows a modification period in which the scheduling SIB is acquired.

31. The UE of claim 25, wherein the scheduling SIB is SIB1 and the updated scheduling SIB is SIB1.

32. The UE of claim 25, wherein the SIB is SIB19 or above.

33. The UE of claim 25, wherein the SIB is included in a subset of SIBs, of the set of SIBs, that excludes SIB18 and below.

34. The UE of claim 25, wherein, to cause the UE to determine whether the UE is required to acquire the SIB included in the set of SIBs, the one or more processors are operable to cause the UE to determine whether the UE is required to acquire the SIB included in the set of SIBs based at least in part on information stored in memory of the UE.

35. (canceled)

36. (canceled)

37. (canceled)

38. (canceled)
